(19) United States
(12) Patent Application Publication
(10) Pub. No.: US 2013/0169795 A1
(43) Pub. Date: Jul. 4, 2013

(54) ILLUMINATION SYSTEM, ILLUMINATION METHOD, AND INSPECTION SYSTEM

(71) Applicant: SHIBAURA MECHATRONICS CORPORATION, Yokahama-shi (JP)

(72) Inventors: Yoshinori HAYASHI, Yokohama-shi (JP); Osamu IZUTSU, Yokohama-shi (JP); Katsutoshi SEKI, Yokohama-shi (JP); Hiroshi WAKABA, Yokohama-shi (JP); Yoko ONO, Yokohama-shi (JP); Takanori GONDO, Yokohama-shi (JP); Akihiko TAKIZAWA, Yokohama-shi (JP)

(73) Assignee: SHIBAURA MECHATRONICS CORPORATION, Yokohama-shi (JP)

(21) Appl. No.: 13/729,434

(22) Filed: Dec. 28, 2012

(30) Foreign Application Priority Data
Dec. 31, 2011 (JP) 2011-290496
Feb. 9, 2012 (JP) 2012-026008

(51) Int. Cl. H05B 37/02; H04N 7/18

(52) U.S. Cl. CPC H05B 37/02
USPC 348/131; 315/294

(57) ABSTRACT

An illumination system includes a first illumination unit which uses an amount of illumination light in accordance with a set amount of light to illuminate an illuminated object, a second illumination unit which has a response to switching of the set amount of light better than said first illumination unit and which uses illumination light which is superposed on the illumination light from said first illumination unit to illuminate said illuminated object, and an illumination controller which controls the amount of illumination light of said second illumination unit by switching the set amount of light in accordance with the control information while maintaining the amount of illumination light of said first illumination unit at a predetermined amount.

### TECHNICAL FIELD

The present invention relates to an illumination system and an illumination method in which an amount of illumination light can be changed and to an inspection system which uses the illumination system.

### BACKGROUND ART

In the past, there has been known the defect inspection system of a transparent sheet member which is described in PLT 1. In this defect inspection system (inspection system), an inspected object, that is, a transparent sheet member, is illuminated by an illumination device which is arranged at one surface side of that transparent sheet member. In that state, a CCD camera which is arranged at the other surface side of the transparent sheet member is used to capture that transparent sheet member. Further, the image which is captured by the CCD camera is processed to thereby detect scratches or other defects in the transparent sheet member.

The illumination device (illumination system) which is used in this defect inspection system uses a halogen lamp, xenon lamp, high pressure mercury lamp, sodium lamp, etc. as a light source. Further, a suitable amount of illumination light of the illumination device is determined to enable an image enabling scratches and other defects to be discerned to be captured by the CCD camera.

### CITATIONS LIST

### Patent Literature

PLT 1: Japanese Patent Publication No. 2001-141662 A1

### SUMMARY OF THE INVENTION

### Technical Problem

In this regard, due to the high amount of illumination light and, further, long lifetime and other advantages, use of the known high brightness LEDs as the light source of the illumination system may be considered. An illumination system which uses such high brightness LEDs as a light source is structured to maintain a high amount of illumination light by, as one example, sealing a plurality of LEDs (light emitting diodes) by a resin in which a phosphor is mixed. However, when emitting light by an initially set initial amount of light and then, in that state, switching the set amount of light to a target amount of light, due to the presence of the phosphor, the structure which is explained above, etc., a relatively long time is taken for the actual amount of illumination light to become the target amount of light (for example, sometimes 20 minutes or so are taken). For this reason, when it is necessary to change the amount of illumination light along with a change in the type of the inspected object, time ends up being taken until the suitable amount of illumination light is reached and therefore the inspection after the change of type of object ends up being delayed. On the other hand, if starting an inspection before the suitable amount of illumination light is reached, good precision inspection would be difficult.

The present invention was made in consideration of such a situation and provides an illumination system and an illumination method which, even if using an illumination unit which requires a relatively long time for the amount of illumination light to reach a target amount of light when switching the set amount of light to the target amount of light like in an illumination system using high brightness LEDs etc. as a light source (that is, which is poor in response to switching of the set amount of light), enable the actual amount of illumination light to be made the target amount of light in a relatively short time when switching the set amount of light.

Further, the present invention provides an inspection system which uses the above such explained illumination system.

### Solution to Problem

The illumination system according to the present invention is constituted having a first illumination unit which uses an amount of illumination light in accordance with a set amount of light to illuminate an illuminated object, a second illumination unit which has a response to switching of the set amount of light better than the first illumination unit and which uses illumination light which is superposed on the illumination light from the first illumination unit to illuminate the illuminated object, and an illumination controller for controlling the amount of illumination light of the second illumination unit by switching the set amount of light in accordance with the control information while maintaining the amount of illumination light of the first illumination unit at a predetermined amount.

The illumination method according to the present invention comprises having a first illumination unit use an amount of illumination light in accordance with a set amount of light to illuminate an illuminated object, having a second illumination unit which has a response to switching of the set amount of light better than the first illumination unit use illumination light which is superposed on the illumination light from the first illumination unit to illuminate the illuminated object, and controlling the amount of illumination light of the second illumination unit by switching the set amount of light in accordance with the control information while maintaining the amount of illumination light of the first illumination unit at a predetermined amount.

Due to these constitutions, the illuminated object is illuminated by the illumination light from the second illumination unit being superposed on the illumination light from the first illumination unit which has been maintained at a predetermined amount. Further, by control for switching the set amount of light in accordance with control information so as to control the amount of illumination light from the second illumination unit, the amount of the illumination light as a whole which is obtained by the superposition of the illumination light from the first illumination unit and the illumination light from the second illumination unit is controlled by the response to switching of the set amount of light of the second illumination unit.

The “response to switching of the set amount of light” means a characteristic based on the time from when switching the set amount of light to the target amount of light to when the amount of illumination light becomes the target amount of light. The shorter the time, the better the response.

Further, the inspection system according to the present invention is constituted having the illumination system which illuminates an inspected object as the illuminated object, a camera unit which captures the inspected object which is illuminated by the illumination system, and a processing system which uses an image which is captured by the camera unit to process the inspected object for inspection.

Due to such a constitution, the inspected object which is illuminated by superposition of the illumination light from the first illumination unit of the amount which is maintained at a predetermined amount and the illumination light from the second illumination unit of the amount which is switched by switching of the set amount of light is captured by the camera unit, and the image which is captured is used to process the inspected object for inspection.

### Advantageous Effects of Invention

According to the illumination system and the illumination method according to the present invention, even if using as the first illumination unit, like an illumination unit using high brightness LEDs etc. as a light source, an illumination unit where the time required from when switching the set amount of light to the target amount of light to when the amount of illumination light reaches the target amount of light is relatively long (that is, an illumination unit with a relatively poor response to switching of the set amount of light), the amount of the illumination light from the first illumination unit is maintained at a predetermined amount and the illumination light from the second illumination unit which is better than the first illumination unit in response to switching of the set amount of light is superposed on the illumination light from the first illumination unit to illuminate the illuminated object. Therefore, when switching the set amount of light of the second illumination unit so as to switch the set amount of light, the amount of illumination light on the illuminated object can be made the target amount of light in a relatively short time (specifically, in a time shorter than the first illumination unit alone).

### BRIEF DESCRIPTION OF THE DRAWINGS

FIG. 1A is a cross-sectional view which shows the structure of a sensor panel assembly (bonded plate-shaped member) which is inspected by an embodiment of the inspection system according to the present invention.

FIG. 1B is a plan view which shows the structure of the sensor panel assembly.

FIG. 1C is a cross-sectional view which shows the structure of a touch panel type of liquid crystal panel comprised of the sensor panel assembly which is shown in FIG. 1A and FIG. 1B and a liquid crystal panel assembly bonded together by a binder.

FIG. 2 is a view which shows the basic constitution of the inspection system according to a first embodiment of the present invention.

FIG. 3 is a view which shows the structure of a light source device which is included in the first illumination apparatus which is used in the inspection system which is shown in FIG. 2.

FIG. 4A is a view which shows an example of the changed characteristic of the amount of illumination light when switching the set amount of light of the first illumination unit from the initial amount of light to a target amount of light which is lower than that.

FIG. 4B is a view which shows an example of the changed characteristic of the amount of illumination light when switching the set amount of light of the first illumination unit from the initial amount of light to a target amount of light which is higher than that.

FIG. 5 is a view of a basic constitution of a processing system of an embodiment of the inspection system according to the present invention.

FIG. 6A is a view which shows an example of the state of switching the amount of illumination light of the second illumination unit.

FIG. 6B is a view which shows an example of the state of switching the amount of illumination light of the first illumination unit and the second illumination unit combined.

FIG. 7 is a view which shows the state of shading correction which is performed in the inspection system.

FIG. 8 is a view which shows a basic constitution of the inspection system according to a second embodiment of the present invention.

FIG. 9 is a view which shows a basic constitution of the inspection system according to a third embodiment of the present invention.

FIG. 10 is a view which shows a basic constitution of the inspection system according to a fourth embodiment of the present invention.

### DESCRIPTION OF THE EMBODIMENT

Embodiments of the present invention will be explained using the drawings.

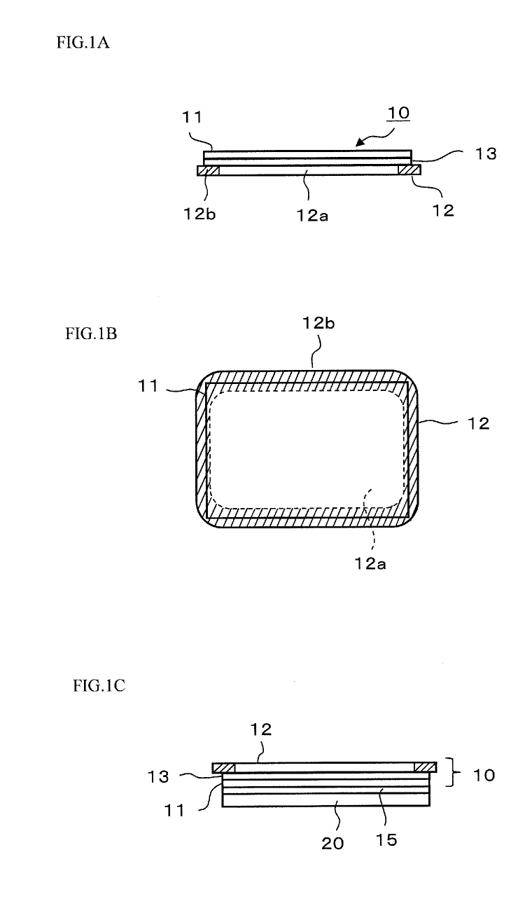

The object which is inspected by an inspection system which uses the illumination system according to an embodiment of the present invention (inspected object) will be explained while referring to FIG. 1A to FIG. 1C. This example is a sensor panel assembly which is used for a touch panel type of liquid crystal display panel. Note that, FIG. 1A is a cross-sectional view which shows the structure of a sensor panel assembly 10, FIG. 1B is a plan view which shows the structure of the sensor panel assembly 10, and FIG. 1C is a cross-sectional view which shows the structure of a touch panel type of liquid crystal panel comprised of the sensor panel assembly 10 and a liquid crystal panel assembly 20 bonded together by a binder.

In FIG. 1A and FIG. 1B, this sensor panel assembly 10 is structured comprised by a sensor panel 11 on which sensor devices or a grid or other circuit components are formed in an array and a cover glass 12 which are bonded together by a binder 13 (resin) which is coated over the entire surface of the sensor panel 11 and has light transmittancy. The sensor panel 11 is structured comprised by a glass substrate on which circuit components are formed and overall forms a light transmitting region which has light transmittancy (however, parts of circuit components not transmitting light). Further, the cover glass 12 has a periphery which forms a predetermined width of non-light transmitting region 12b (black region). The region inside of that forms a light transmitting region 12a which has light transmittancy.

Such a structure of a sensor panel assembly 10, as shown in FIG. 1C, is bonded by a binder 15 which has light transmittancy with respect to the liquid crystal panel assembly 20 (comprised of liquid crystal panel, color filter, polarizer, etc.) In the thus formed touch panel type of liquid crystal display panel, the liquid crystal panel assembly 20 is used to display an image, and sensor devices on the sensor panel 11 which correspond to positions on the cover glass 12 which are touched by the finger are used to output signals. Further, the signals which are output from the sensor devices of this sensor panel 11 can be used to control the display of the image by the liquid crystal panel assembly 20.

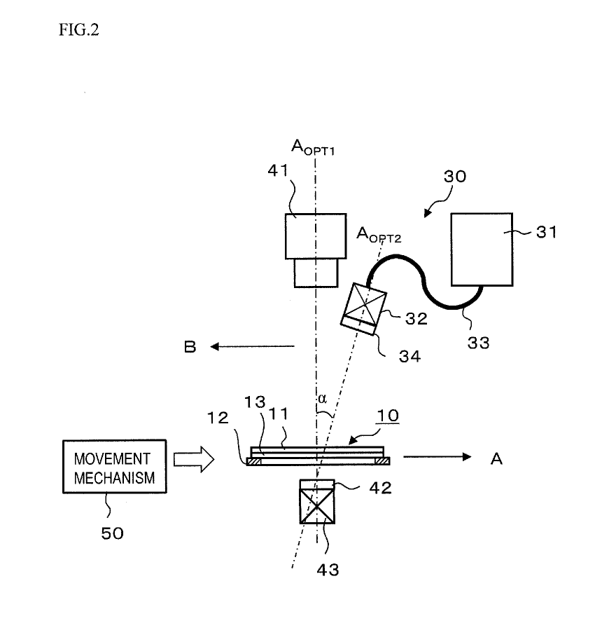

In the process of producing the above-mentioned such structure of sensor panel assembly 10, sometimes bubbles will form inside of the binder 13 or dust or other foreign matter will enter the binder 13. Further, sometimes the binder 13 will be squeezed out from between the sensor panel 11 and the cover glass 12 or the binder 13 will become insufficient. An inspection system for inspecting for such defects in the sensor panel assembly 10 is, for example, constituted as shown in FIG. 2.

In FIG. 2, this inspection system has a line sensor camera 41 (camera unit), a first illumination unit 30, a reflector 42 which has a diffusion function, a second illumination unit 43, and a movement mechanism 50. The first illumination unit 30 and the second illumination unit 43 are used to constitute the illumination system which is used in the inspection system. The movement mechanism 50 makes a sensor panel assembly 10 which has been set on a path of movement in a state with the sensor panel 11 facing upward and the cover glass 12 facing downward move linearly by a predetermined speed. The line sensor camera 41, for example, includes a line sensor which is constituted by a string of CCD elements and a group of lenses (able to include lens for enlargement for broadening field of view) and other parts of an optical system and is arranged fastened so as to face the sensor panel 11 of the sensor panel assembly 10 on the path of movement. Further, the posture of the line sensor camera 41 is adjusted so that the direction in which the line sensor (string of CCD elements) of this line sensor camera 41 extends cuts across a movement direction A of the sensor panel assembly 10 (for example, perpendicularly intersects the movement direction A) and so that its optical axis A_{OPT1} perpendicularly intersects the surface of the sensor panel assembly 10 (sensor panel 11). The reflector 42 has a reflection surface which is processed to reflect incident light by diffused reflection and is arranged fastened near the sensor panel assembly 10 on the path of movement so that the reflection surface faces the cover glass 12 of the sensor panel assembly 10. Due to the diffused reflection at the thus arranged reflector 42, light is illuminated from the cover glass 12 side of the sensor panel assembly 10 toward the line sensor camera 41.

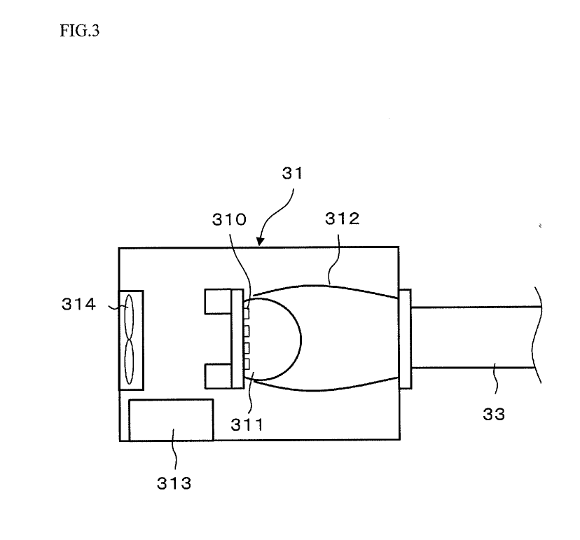

The first illumination unit 30 has a light source device 31, an illumination head 32, a light guide 33 which guides the light emitted from the light source device 31 to the illumination head 32, and a light condenser 34 which is bonded to the emission surface of the light of the illumination head 32 and enables adjustment of the focusing position. The light source device 31, for example, as shown in FIG. 3, has a high brightness LED unit 311, a light guide mirror 312, a power source unit 313, and a cooling fan 314. The high brightness LED unit 311 is structured comprised of a large number of LEDs 310 (light emitting diodes) sealed by a resin containing a phosphor. The high brightness LED unit 311 receives electric power from the power source unit 313, makes the individual LEDs 310 emit light, and uses the light emission of the phosphor accompanying this to illuminate the entire resin sealed assembly with light. The light which is emitted from the high brightness LED unit 311 is guided by the light guide mirror 312 to strike the end of the light guide 33. This light is propagated along the light guide 33 and emitted from the illumination head 32 (see FIG. 2). The high brightness LED unit 311 which contains the large number of light emitting LEDs 310 is cooled by the cooling fan 314 whereby its operating temperature is kept within a prescribed temperature range.

The illumination head 32 of the first illumination unit 30 is arranged at the downstream side of the line sensor camera 41 in the movement direction A of the sensor panel assembly 10 on the path of movement, that is, at the upstream side of the line sensor camera 41 in the scan direction B of the line sensor camera 41, so as to face the sensor panel 11. The posture of the illumination head 32 is adjusted so as to illuminate the surface of the sensor panel assembly 10 from a slant above the sensor panel assembly 10 (specifically, from a direction whereby the optical axis A_{OPT2} becomes a predetermined angle α with respect to the normal direction of the surface of the sensor panel assembly 10 (sensor panel 11)) without cutting across the optical axis A_{OPT1} of the line sensor camera 41. Due to such adjustment, part of the light which is emitted from the illumination head 32 of the first illumination unit 30 is reflected at the surface of the inspected sensor panel assembly 10 and strikes the line sensor camera 41. Further, another part of the light which is emitted from the illumination head 32 passes through the sensor panel assembly 10 and is reflected at the reflector 42 by diffused reflection. Part of the diffused reflected light then passes through the sensor panel assembly 10 and strikes the line sensor camera 41.

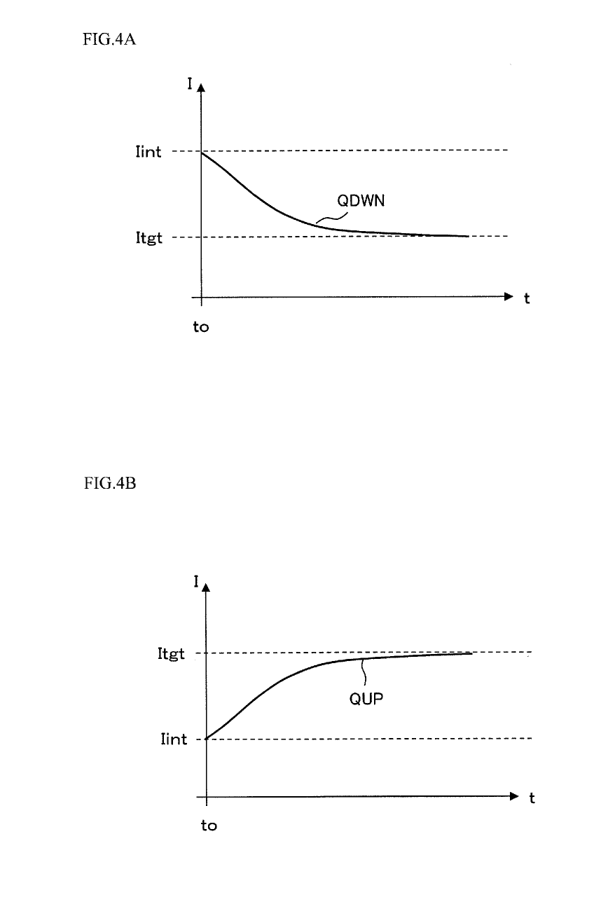

In control for adjusting the light of the first illumination unit 30 which includes the above-mentioned such high brightness LED unit 311, when switching the set amount of light from the initial amount of light Iᵢₙₜ to the target amount of light I_{tgt}, it takes time until the actual amount of illumination light of the first illumination unit 30 reaches the target amount of light I_{tgt} (for example, when the target amount of light I_{tgt} is lower than the initial amount of light Iᵢₙₜ, as shown in FIG. 4A by the curve QDWN, further, when the target amount of light I_{tgt} is higher than the initial amount of light Iᵢₙₜ, as shown in FIG. 4B by the curve QUP) (for example, 20 minutes or so). This is due, as explained above, to the presence of the phosphor and the large number of LEDs 310 in the high brightness LED unit 311 sealed by a resin containing a phosphor (see FIG. 3). Note that, in FIG. 4A and FIG. 4B, the ordinate indicates the amount of illumination light and the abscissa indicates the elapsed time from when switching the amount of illumination light.

The second illumination unit 43 is arranged at the side of the surface of the reflector 42 which has a diffusion function at the opposite side to the reflection surface so that its optical axis is aligned with the optical axis A_{OPT1} of the line sensor camera 41. The illumination light from the second illumination unit 43 passes through the reflector 42 to be superposed with the component of the illumination light from the first illumination unit 30 which is reflected at the reflector 42, passes through the sensor panel assembly 10 (illuminated object/inspected object), and strikes the line sensor camera 41. In this way, the sensor panel assembly 10 is illuminated by the illumination light of the superposition of the illumination light from the first illumination unit 30 and the illumination light from the second illumination unit 43.

The second illumination unit 43 includes low brightness LEDs (for example, ordinary LEDs in which no phosphor is contained in the sealed member) as the light source, is better in response to switching of the set amount of light (characteristic based on the time from when switching the set amount of light to the target amount of light I_{tgt} to when the amount of illumination light becomes the target amount of light I_{tgt}) than the first illumination unit 30, and enables switching of the amount of illumination light without almost any delay at the time of switching.

In such a structure of an inspection system, the movement mechanism 50 is used so that the sensor panel assembly 10 moves on the path of movement in the direction A, whereby the relative positional relationship between the line sensor camera 41 and the illumination head 32 (first illumination unit 30) and second illumination unit 43 is maintained while making the line sensor camera 41 optically scan the sensor panel assembly 10 in the reverse direction to the movement direction A. Due to this scan, the line sensor camera 41 captures the sensor panel assembly 10.

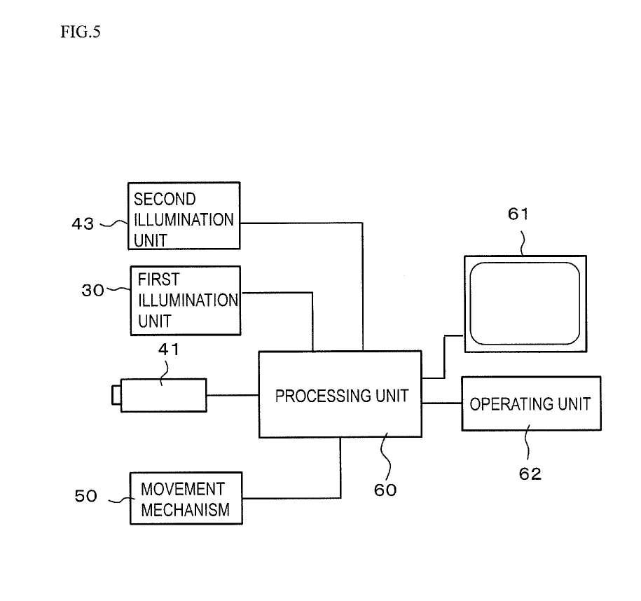

The processing system of the inspection system is constituted as shown in FIG. 5.

In FIG. 5, the processing unit 60 is connected to the line sensor camera 41 and is connected to the display unit 61 and operating unit 62 and, furthermore, the first illumination unit 30 (light source device 31) and the second illumination unit 43. The processing unit 60, synchronized with movement of the sensor panel assembly 10 (illuminated object/inspected object) by the movement mechanism 50, receives as input an image signal from the line sensor camera 41 which optically scans the sensor panel assembly 10 and uses that image signal as the basis to produce test image data which expresses an image of the sensor panel assembly 10.

The processing unit 60 functions as an illumination controller and performs control to switch the amount of illumination light of the second illumination unit 43 with the good response to switching of the set amount of light in accordance with the control information. The control information is provided from another system or from an operating unit 62 which is operated by an operator when switching of the type of the inspected sensor panel assembly 10 makes it necessary to switch the amount of illumination light. Further, the processing unit 60 controls the first illumination unit 30 (light source device 31) so that a predetermined amount of light is maintained regardless of the type of the sensor panel assembly 10.

Further, the processing unit 60 uses the produced test image data as the basis to make the display unit 71 display an image of the sensor panel assembly 10 and, further, uses that test image data to perform inspection processing.

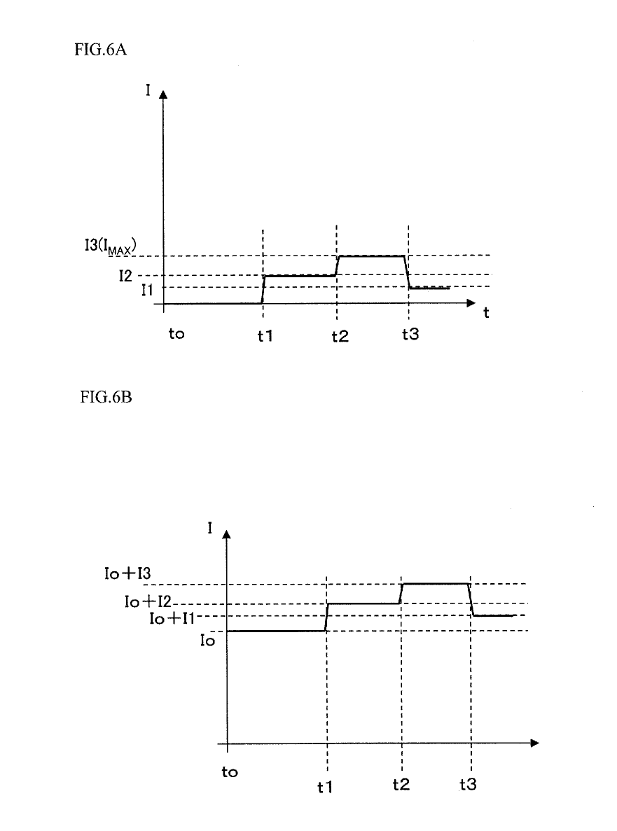

In such an inspection system, the amount of illumination light of the second illumination unit 43 with a good response to switching of the set amount of light is controlled to be switched within a range of up to the maximum amount of light I_{MAX} (I3). For example, as shown in FIG. 6A, at the timings t1, t2, and t3 when the type of the inspected sensor panel assembly 10 is switched, the amount of illumination light is switched from zero to I2, from I2 to I3 (I_{MAX}), and, furthermore, from I3 to I1. At this time, the amount of illumination light of the first illumination unit 30 which contains the high brightness LED unit 311 as a light source is maintained at the predetermined amount of light Io. As a result, as shown in FIG. 6B, the illumination light from the first illumination unit 30 and the illumination light from the second illumination unit 43 are superposed and, at the timings t1, t2, and t3 when the type of the inspected sensor panel assembly 10 is switched, the set amount of light is switched from Io to (Io+I2), from (Io+I2) to (Io+I3(I_{MAX})), and, furthermore, from (Io+I3) to (Io+I1), so as to give the amount of illumination light suitable for each type.

Note that, in the example which is shown in FIG. 6B, in the case of a sensor panel assembly where the suitable amount of illumination light at the time of inspection is Io, the amount of illumination light of the second illumination unit 43 becomes zero. When envisioning the state where the first illumination unit 30 deteriorates or other reasons arise and thereby cause the predetermined amount of light Io to no longer be able to be maintained, it is also possible to set the predetermined amount of light Io at a value further lower than the lowest value of suitable amounts of illumination light at the time of inspection among a plurality of types of sensor panel assemblies to be inspected and prevent the amount of illumination light of the second illumination unit 43 from becoming zero so as to obtain the suitable amount of illumination light.

Further, in this case, for example, it is possible to place an illuminometer at part of the movement mechanism 50 and use the output value of this illuminometer as the basis to automatically adjust the amount of illumination light of the second illumination unit 43 or to have an operator change it.

Note that, in the explanation of FIG. 6B, to facilitate understanding, all of the illumination light from the first illumination unit 30 was deemed to be superposed with all of the illumination light from the second illumination unit 43, but in actuality, part of the illumination light from the first illumination unit 30 is superposed with part of the illumination light from the second illumination unit 43 to contribute to illumination of the inspected object, that is, the sensor panel unit 10.

According to such an inspection system, the illumination light from the first illumination unit 30 which uses a high brightness LED unit 311 as a light source and which has a poor response to switching of the set amount of light and the illumination light from the second illumination unit 43 which uses low brightness LEDs as a light source and which has a response to switching of the set amount of light which is better than the first illumination unit 30 are superposed to illuminate the sensor panel assembly 10. The amount of illumination light from the first illumination unit 30 is maintained at a predetermined amount Io while the amount of illumination light from the second illumination unit 43 is controlled to be switched by switching the set amount of light, so the amount of illumination light for illuminating the sensor panel assembly 10 can be made the target amount of light in a shorter time compared with the first illumination unit 30 alone, for example, from right after switching. As a result, it is possible to efficiently perform suitable inspection for a large number of types of sensor panel assemblies.

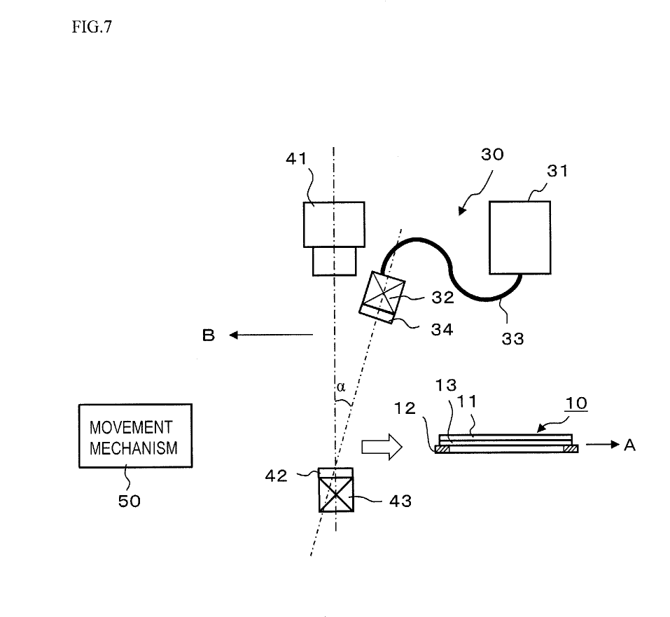

Note that, in the above-mentioned inspection system, when performing adjustment for shading correction, as shown in FIG. 7, the sensor panel assembly 10 is retracted so that the inspected object, that is, the sensor panel assembly 10, is not struck by illumination light from the first illumination unit 30 and the second illumination unit 43.

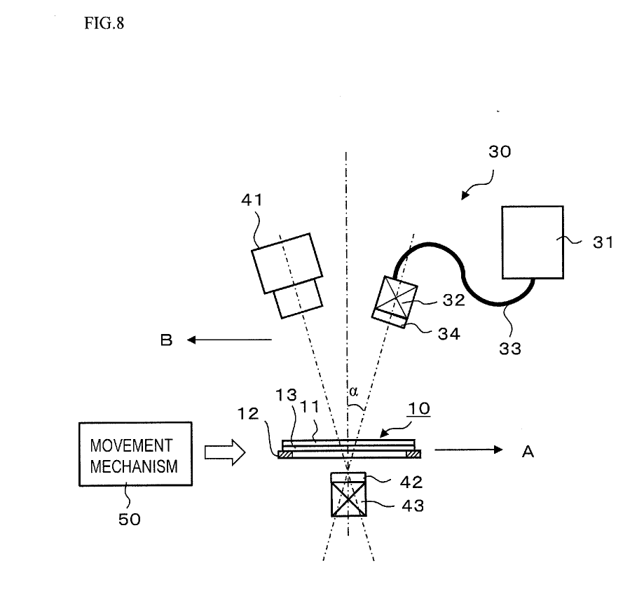

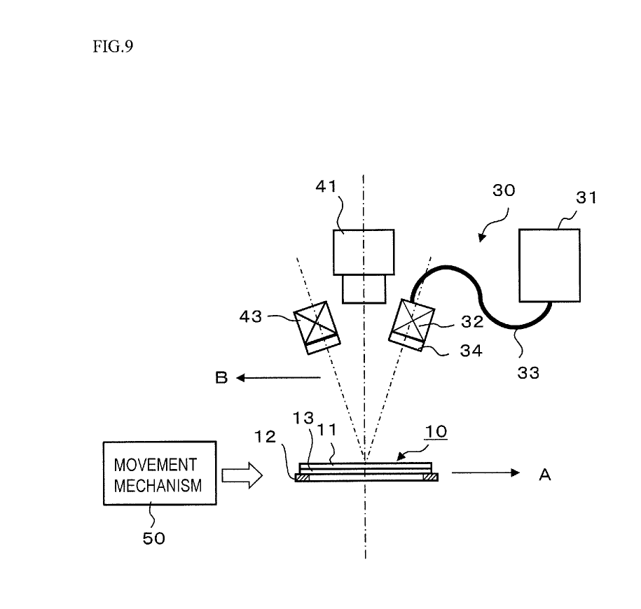

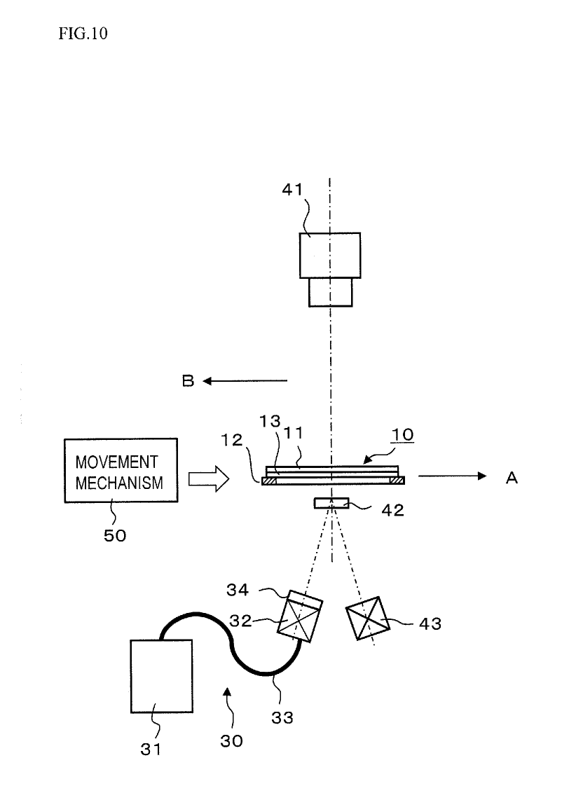

The relative positional relationship of the first illumination unit 30, the second illumination unit 43, the line sensor camera 41, and the inspected object of the sensor panel assembly 10 is not limited to the one explained in the above-mentioned inspection system. For example, as shown in FIG. 8, the optical axis of the line sensor camera 41 may also be made to incline from the vertical direction. Further, as shown in FIG. 9, the second illumination unit 43 may be arranged across the line sensor camera 41 at the opposite side to the first illumination unit 30. In this case, both the illumination light from the first illumination unit 30 and the illumination light from the second illumination unit 43 are reflected at the sensor panel assembly 10 and strike the line sensor camera 41. Furthermore, as shown in FIG. 10, the first illumination unit 30 and the second illumination unit 43 may also be arranged at the back of the reflector 42. In this case, both the illumination light from the first illumination unit 30 and the illumination light from the second illumination unit 43 pass via the reflector 42 through the sensor panel assembly 10 with the transmitted light then striking the line sensor camera 41.

Further, in the above embodiment, the illumination system according to the present invention was applied to an inspection system, but the illumination system according to the present invention may also for example be used in place of a metal halide lamp which is used as the light source of an optical microscope or for something else besides an inspection system.

Furthermore, in the above embodiment, the example was shown of provision of one first illumination unit and one second illumination unit each, but the invention is not limited to these numbers. One may be a single unit and the other a plurality, both may be pluralities, etc. Any combination is possible.

### REFERENCE NUMBER LIST

10 sensor panel assembly (illuminated object or inspected object)
11 sensor panel
12 cover glass
13, 15 binder
20 liquid crystal panel assembly
30 first illumination unit
31 light source device
32 illumination head
33 light guide
34 light condenser
41 line sensor camera (camera unit)
42 reflector (diffuser)
43 second illumination unit
50 movement mechanism
60 processing unit
61 display unit
62 operating unit
311 high brightness LED unit
312 light guide mirror
313 power source unit
314 cooling fan

1. An illumination system comprising:
a first illumination unit which uses an amount of illumination light in accordance with a set amount of light to illuminate an illuminated object,
a second illumination unit which has a response to switching of the set amount of light better than said first illumination unit and which uses illumination light which is superposed on the illumination light from said first illumination unit to illuminate said illuminated object, and
an illumination controller which controls the amount of illumination light of said second illumination unit by switching the set amount of light in accordance with the control information while maintaining the amount of illumination light of said first illumination unit at a predetermined amount.

2. The illumination system as set forth in claim 1 wherein said first illumination unit uses a high brightness LED as a light source.

3. A illumination method comprising:
having a first illumination unit use an amount of illumination light in accordance with a set amount of light to illuminate an illuminated object,
having a second illumination unit which has a response to switching of the set amount of light better than said first illumination unit use illumination light which is superposed on the illumination light from said first illumination unit to illuminate said illuminated object, and
maintaining the amount of illumination light of said first illumination unit at a predetermined amount while controlling the amount of illumination light of said second illumination unit by switching the set amount of light in accordance with the control information.

4. An inspection system comprising:
an illumination system as set forth in claim 1 which illuminates an inspected object as an illuminated object,
a camera unit which captures said inspected object which is illuminated by said illumination system, and
a processing unit which uses an image which is captured by said camera unit to process said inspected object for inspection.

5. An inspection system comprising:
an illumination system as set forth in claim 2 which illuminates an inspected object as an illuminated object,
a camera unit which captures said inspected object which is illuminated by said illumination system, and
a processing unit which uses an image which is captured by said camera unit to process said inspected object for inspection.
